(19) United States
(12) Patent Application Publication
(10) Pub. No.: US 2024/0286524 A1
(43) Pub. Date: Aug. 29, 2024

(54) HIGH-VOLTAGE ELECTRICAL SYSTEMS PAIRING SOLID-STATE RELAYS WITH ELECTROMECHANICAL CONTACTORS FOR GALVANIC DISCONNECT

(71) Applicant: GM GLOBAL TECHNOLOGY OPERATIONS LLC, Detroit, MI (US)

(72) Inventors: Richard England, Smithfield, UT (US); Christopher A. Schlaupitz, White Lake, MI (US); Robert J. Heydel, Clawson, MI (US); Caitlin J. Babul, Grosse Point Woods, MI (US)

(73) Assignee: GM GLOBAL TECHNOLOGY OPERATIONS LLC, Detroit, MI (US)

(21) Appl. No.: 18/173,161

(22) Filed: Feb. 23, 2023

(51) Int. Cl. B60L 58/21; H02J 7/00

(52) U.S. Cl. CPC B60L 58/21; H02J 7/007182; B60L 2240/547; B60L 2240/549; H02J 2310/48

(57) ABSTRACT

Presented are high-voltage (HV) electrical systems pairing solid-state relays (SSRs) with electromechanical contactors for optimized galvanic disconnect, methods for making/using such systems, and vehicles equipped with such systems. An HV electrical system includes a first circuit loop that connects a rechargeable energy storage system (RESS) to an electrified powertrain. A second circuit loop, which is parallel to the first circuit loop, connects the RESS to a charge inlet of a battery charging system. A first contactor switch on the first circuit loop serially connects with the powertrain's electric motor and a first terminal of a RESS battery assembly. A second contactor switch on the second circuit loop serially connects with the charge inlet and the first terminal. One or more SSR switches electrically connect in series with a second terminal of the battery assembly, the electric motor and/or charge inlet, and the two contactor switches across the battery assembly.

### INTRODUCTION

The present disclosure relates generally to high-voltage electrical systems. More specifically, aspects of this disclosure relate to electrical switch architectures for actively disconnecting rechargeable energy storage systems from electrified powertrains.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability and relatively inexpensive cost, light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a fossil-fuel based engine for tractive power.

A full-electric vehicle (FEV)—colloquially labeled an “electric car”—is a type of electric-drive vehicle configuration that altogether omits an internal combustion engine and attendant peripheral components from the powertrain system, relying instead on a rechargeable energy storage system (RESS) and a traction motor for vehicle propulsion. The engine assembly, fuel supply system, and exhaust system of an ICE-based vehicle are replaced with a single or multiple traction motors, rechargeable battery cells, and battery cooling and charging hardware in a battery-based FEV. Hybrid-electric vehicle (HEV) powertrains, in contrast, employ multiple sources of tractive power to propel the vehicle, most commonly operating an internal combustion engine assembly in conjunction with a battery-powered or fuel-cell-powered traction motor. Since hybrid-type, electric-drive vehicles are able to derive power from sources other than the engine, HEV engines may be turned off, in whole or in part, while the vehicle is propelled by the electric motor(s).

High-voltage (HV) electrical systems govern the transfer of electricity between the traction motors and the rechargeable battery packs that supply the requisite power for operating many hybrid-electric and full-electric powertrains. To provide the power capacity and energy density needed to propel a vehicle at desired speeds for desired ranges, contemporary traction battery packs group multiple battery cells (e.g., 8-16+ cells/stack) into individual battery modules (e.g., 10-40+ modules/pack) that are electrically interconnected in series or parallel and mounted onto the vehicle chassis, e.g., by a battery pack housing or support tray. Located on a battery side of the HV electric system is a front-end DC-to-DC power converter that is electrically connected to the traction battery pack(s) in order to increase the supply of voltage to a main DC bus and a DC-to-AC power inverter module (PIM). A high-frequency bulk capacitor may be arranged across the positive and negative terminals of the main DC bus to provide electrical stability and store supplemental electrical energy. A dedicated Electronic Battery Control Module (EBCM), through collaborative operation with a Powertrain Control Module (PCM) and each motor's power electronics package, governs operation of the battery pack(s) and traction motor(s).

A plug-in electric vehicle (PEV) is any electric-drive motor vehicle in which the on-board RESS contains one or more HV traction battery packs that are rechargeable from an external power source, such as a public power utility grid by way of an electric vehicle charging station (EVCS) with a manually operated charging cable. The RESS typically employs a distributed array of high-voltage, electromechanical contactor switches (“contactors”) that provision selective electrical connection and disconnection of the battery pack(s) to and from the external power source, e.g., during pack charge, and the on-board power inverter module (PIM), DC/DC converter, high-voltage auxiliary loads, accessory loads, etc., e.g., during pack discharge. When the vehicle is powered, a designated subset of the contactors may be energized at a static or nominal power level, which may be a maximum power level for the HV contactor, to ensure that the contactors remain in a closed state to ensure a consistent and reliable current draw through the RESS. To protect the vehicle's traction battery pack(s) against unsolicited discharge scenarios, the RESS may employ a battery disconnect unit (BDU) to electrically disconnect the vehicle battery cells from the HV electrical system in the event of a short circuit or fault condition.

### SUMMARY

Presented herein are high-voltage electrical systems pairing solid-state relay (SSR) switches with electromechanical contactor switches for optimized galvanic disconnect functionality, methods for making and methods for operating such HV electrical systems, and motor vehicles equipped with such electrical systems. In an example, a RESS contains at least one multi-cell traction battery pack that electrically connects via an HV electrical system to an electrified powertrain, including automotive and non-automotive applications alike. Each battery pack has a cathode terminal that is positive during pack discharge and negative during pack recharge, and an anode terminal that is negative during pack discharge and positive during pack recharge. The electrified powertrain may be typified by an electric machine, such as an integrated electric drive unit (EDU) with a polyphase motor generator unit (MGU), a gearbox, and power electronics package, that is electrically interconnected with a traction power inverter module (TPIM) and an onboard charge module (OBCM).

Cooperatively enabling pack discharge to the powertrain is a main SSR that is located on a main circuit loop downstream from the pack's cathode terminal and operatively paired in series-power-flow communication with a main contactor located on the main circuit loop upstream from the pack's anode terminal. Cooperatively enabling pack recharge from an EVCS charge inlet is a DCFC (direct-current fast charge) SSR that is located on a DCFC circuit loop upstream from the cathode terminal and operatively paired in series-power-flow communication with a DCFC contactor located on the DCFC circuit loop downstream from the anode terminal. In this case, the two SSRs connect at a T-junction node, the two contactors connect at a T-junction node, the first mated switches are opened/closed in unison, and the second mated switches are opened/closed in unison yet opposite that of the first mated switches. Alternatively, the two SSRs may be replaced by a single bidirectional SSR that is located downstream (or upstream during recharge) from the pack's cathode terminal; in this case, the two contactors are each serially connected to the pack's anode terminal and connected to each other at a T-junction. For a dual-pack RESS architecture, each pack may be serially connected with a respective bidirectional SSR, a respective DCFC contactor, and a respective main contactor. In this case, the anode terminal of a first battery pack is serially connected to the cathode terminal of a second battery pack via a serially connected contactor-fuse-contactor circuit branch.

Attendant benefits for at least some of the disclosed concepts include HV electrical systems that pair solid state relays with electronic contactors for improved galvanic disconnect functionality at DCFC and main discharge junctions. This architecture eliminates the use of pre-charge circuits—a pre-charge resistor parallel connected to the main contactor via a pre-charge contactor—for protecting the main contactor from a sudden in-rush of current as the SSRs are capable of pulsing at startup and, thus, reducing voltage and current rush into HV components powered by the RESS. Another benefit may include the ability to achieve full galvanic disconnect of the RESS using the mated contactors since the SSRs may not be able to achieve full disconnect on their own. Other attendant benefits may include each mated switch protecting the other: the contactor may be closed first, and the SSR second, eliminating the risk of failure in the contactor; and the contactor may also act as a protection device to disconnect the system if the SSR fails closed during use. Disclosed systems also provide increased system protection during a collision event since, unlike electromechanical contactor BDU designs, SSRs do not have mechanical switch parts that risk closing due to collision-borne G-forces. Additionally, disclosed HV electrical systems may use SSRs in tandem with data gathered from current sensors to enable a disconnect strategy that helps to eliminate electrical fuses and gives the added benefit that the RESS may be reset without invasive procedures to replace electrical fuses.

Aspects of this disclosure are directed to high-voltage electrical systems that pair solid-state relay switches with electromechanical contactor switches for optimized galvanic disconnect functionality for both automotive and non-automotive applications. In an example, there is presented an HV electrical system for connecting a battery assembly of a RESS (e.g., a high-capacity, deep-cycle traction battery pack or module) to an electric motor of an electrified powertrain (e.g., a polyphase traction MGU) and to a charge inlet of a battery charging system (e.g., a DCFC charger cable port). The HV electrical system includes a first (main) circuit loop that electrically connects the RESS to the electrified powertrain, and a second (DCFC) circuit loop that is parallel to the first circuit loop and electrically connects the RESS to the charge inlet. A first (main) contactor switch is located on the first circuit loop and electrically connects in series with the electric motor and a first (e.g., anode) terminal of the battery assembly. A second (DCFC) contactor switch is located on the second circuit loop and electrically connects in series with the charge inlet and the first battery terminal. A single or multiple SSR switches serially connect with the first and second contactor switches across the battery assembly (i.e., with the battery assembly electrically interposed between the SSR switch(es) and the contactor switches). Each SSR switch electrically connects in series with a second (e.g., cathode) terminal of the battery assembly and one or both of the electric motor and charge inlet.

Additional aspects of this disclosure are directed to electric-drive vehicles with HV electrical systems that pair SSR switches with contactor switches for optimized BDU operation. As used herein, the terms “vehicle” and “motor vehicle” may be used interchangeably and synonymously to include any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles, motorcycles, farm equipment, watercraft, aircraft, e-bikes, etc. In an example, a motor vehicle includes a vehicle body with a passenger compartment, multiple road wheels mounted to the vehicle body (e.g., via corner modules coupled to a unibody or body-on-frame chassis), and other standard original equipment. For electric-drive vehicle applications, the vehicle's electrified powertrain employs one or more electric traction motors, which operate alone (e.g., for FEV powertrains) or in conjunction with an internal combustion engine assembly (e.g., for HEV powertrains), to selectively drive one or more of the road wheels to propel the vehicle. A RESS with a battery assembly, which may be in the nature of a chassis-mounted HV traction battery pack, is operable to power the traction motor(s). Also packaged on the vehicle body is an electric vehicle battery (EVB) charging system with a charge inlet that connects, e.g., wirelessly or by-wire, to an off-board power source, such as a Level 1, 2, or 3 direct-current (DC) vehicle charging station.

Continuing with the discussion of the preceding example, the vehicle also includes a high-voltage electrical system with a first circuit loop that electrically connects the RESS to the vehicle's electrified powertrain, and a second circuit loop that is parallel to the first circuit loop and electrically connects the RESS to the charge inlet. A first contactor switch on the first circuit loop electrically connects in series with the electric motor and a first terminal of the battery assembly. Comparatively, a second contactor switch on the second circuit loop electrically connects in series with the charge inlet and the first battery terminal. At least one solid-state relay switch electrically connects in series with the battery assembly's second terminal, the electric motor and/or charge inlet, and the first and/or second contactor switches across the battery assembly.

Aspects of this disclosure are also directed to manufacturing workflow processes, computer-readable media, and control logic for making or for using any of the disclosed HV electrical systems, RESS, and/or motor vehicles. In an example, a method is presented for assembling a high-voltage electrical system for connecting a battery assembly of a rechargeable energy storage system to an electric motor of an electrified powertrain and a charge inlet of a battery charging system. This representative method includes, in any order and in any combination with any of the above and below disclosed options and features: connecting the RESS to the electrified powertrain via a first circuit loop; connecting the RESS to the charge inlet via a second circuit loop parallel to the first circuit loop; connecting a first contactor switch to the first circuit loop in electrical series with the electric motor and the first battery terminal; connecting a second contactor switch to the second circuit loop in electrical series with the charge inlet and the first battery terminal; connecting a solid-state relay switch in electrical series with the first contactor switch and/or the second contactor switch across the battery assembly; and connecting the SSR switch in electrical series with the second battery terminal and the electric motor and/or the charge inlet.

For any of the disclosed systems, methods, and vehicles, the HV electrical system may include a first SSR switch on the first circuit loop and serially connected to the first contactor switch across the battery assembly, and a second SSR switch on the second circuit loop and serially connected to the second contactor switch across the battery assembly. In this example, the first SSR switch is operable in conjunction with the first contactor switch to selectively serially connect/disconnect the second battery terminal to/from the electric motor to thereby transmit current from the second battery terminal in a first direction, e.g., from the cathode terminal, across the first circuit loop to the anode terminal. Likewise, the second SSR switch is operable in conjunction with the second contactor switch to selectively serially connect/disconnect the charge inlet to/from the second battery terminal to thereby transmit current to the second battery terminal in a second direction opposite the first direction, e.g., from the anode terminal, across the second circuit loop, to the cathode terminal.

For any of the disclosed systems, methods, and vehicles, the first SSR switch may be located on a first circuit branch, the second SSR switch may be located on a second circuit branch, and the first and second circuit branches may connect at a first T-junction node, which connects the SSR switches and their respective circuit branches to the second battery terminal. With the foregoing arrangement, the first and second circuit branches are neither connected in series nor in parallel. In the same vein, the first contactor switch may be located on a third circuit branch, the second contactor switch may be located on a fourth circuit branch, and the third and fourth circuit branches connect at a second T-junction node, which connects the contactor switches and their respective circuit branches to the first battery terminal. With the foregoing arrangement, the third and fourth circuit branches are neither connected in series nor in parallel.

For any of the disclosed systems, methods, and vehicles, the HV electrical may include a system control module, such as an EBCM and/or an OBCM, that is programmed to receive battery charge and discharge requests. Upon receiving a battery discharge request, for example, the system control module may responsively concurrently command the first contactor switch and the first SSR switch to close and the second contactor switch and the second SSR switch to open. Upon receiving a battery charge request, the system control module may responsively concurrently command the first contactor switch and the first SSR switch to open and the second contactor switch and the second SSR switch to close. As another option, the HV electrical system may be characterized by a lack of a pre-charge circuit that is electrically connected in parallel with either of the contactor switches. In this instance, the pre-charge circuit may include a pre-charge contactor that is serially connected to a pre-charge resistor. As another option, each SSR switch may include a respective unidirectional or bidirectional electronic semiconductor switch device.

For any of the disclosed systems, methods, and vehicles, the SSR switch may include a single bidirectional SSR switch on both the first and second circuit loops and serially connected to both contactor switches across the battery assembly. In this instance, the bidirectional SSR switch may be located on a first circuit branch on a first side of the battery assembly, the first contactor switch may be located on a second circuit branch on a second side of the battery assembly, and the second contactor switch may be located on a third circuit branch on the second side of the battery assembly, with the second and third circuit branches connected to each other and to the first battery terminal via a first T-junction node. As another option, the HV electrical circuit may include two bidirectional SSR switches: a first bidirectional SSR switch on both circuit loops and serially connected with a battery terminal of a first battery assembly; and a second bidirectional SSR switch on both circuit loops and serially connected with a battery terminal of a second battery assembly. In this instance, the HV electrical circuit may also include a battery circuit branch that is interposed between and serially connects a first battery terminal of the first battery assembly to a second battery terminal of the second battery assembly. This battery circuit branch may include an electrical fuse that is serially connected to and interposed between third and fourth contactor switches.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle with an electrified powertrain that is powered by and electrically connected to a rechargeable energy storage system via a high-voltage electrical system with solid state relay switches paired with contactor switches in accord with aspects of this disclosure.

FIG. 2 is a schematic illustration of a representative electrified powertrain that is electrically connected to a single-pack RESS via an HV electrical system with multiple SSR switches each paired with a respective electromechanical contactor switch for automated BDU disconnect functionality in accord with aspects of the present disclosure.

FIG. 3 is a schematic illustration of a representative HV electrical system for a single-pack RESS with a solitary bidirectional SSR paired with two electromechanical contactors for automated BDU disconnect in accord with aspects of the present disclosure.

FIG. 4 is a schematic illustration of a representative HV electrical system for a dual-pack RESS with multiple bidirectional SSRs each paired in series with multiple electromechanical contactors for automated HV disconnect in accord with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise. Moreover, recitation of “first”, “second”, “third”, etc., in the specification or claims is not used to establish a serial or numerical limitation; rather, these designations may be used for ease of reference to similar features in the specification and drawings and to demarcate between similar elements in the claims.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

Discussed below are high-voltage electrical systems that pair solid-state relay (SSR) switches with electromechanical contactor switches for increased system protection, pre-charge circuit elimination, and optimized HV galvanic disconnect. The SSR switches enable the handling of high voltage and high current operating conditions while eliminating mechanical switch hardware that may inadvertently close during a collision event. Each SSR switch is paired with an electromechanical contactor switch to enable complete galvanic disconnect and eliminate the inadvertent transmission of current across the SSR when in an open state. Each switch may be appropriately specked in its size and its voltage and current ratings to the battery system's operating levels and to ensure compatibility with its mated switch. In addition to improved disconnect functionality and reduced system complexity/cost, implementation of disclosed HV electrical systems may also help to militate against the unintended closing of a circuit loop caused by a contactor arcing and welding shut. Implementation of mated SSR-and-contactor pairs in tandem with real-time, closed-loop feedback data from in-line current sensors may help to reduce or outright eliminate electrical fuses from the RESS BDU and, thus, provide the ability to reset the electrical system to a functional state without the time and cost associated with invasive procedures for replacing blown fuses.

A high-voltage disconnection point has a positive node and a negative node; an SSR switch is implemented on the positive node (or the negative node) and is mated in serial power-flow communication with a contractor switch that is implemented on the negative node (or the positive node) opposite that from the SSR. A solid-state relay is an electronic, semiconductor-based switching device that switches on or off when an external voltage (AC or DC) is applied across its control terminals. In contrast to electromechanical contactors, SSR switches contain no moving parts and, thus, have a longer operational lifetime, are smaller, and are not prone to G-force shock. When paired together, the high-power disconnection capabilities of an SSR allow for the SSR to be in an open (disconnected) state when its mated contactor is in a closed (connected) state, eliminating the risk of arcing and failure of the contactor. In addition, an SSR switch has the ability to “pulse” at system startup, essentially ramping-up the electrical current applied to system loads and, thus, eliminating the need for a pre-charge circuit. Non-limiting examples of SSR switches that may be employed in HV electrical circuits for interconnecting HV RESSs with electrified powertrains are presented in U.S. Pat. Nos. 10,665,398 B1, 11,171,571 B2, 11,349,470 B2 and 11,476,507 B2, all of which are incorporated herein by reference in their respective entireties and for all purposes.

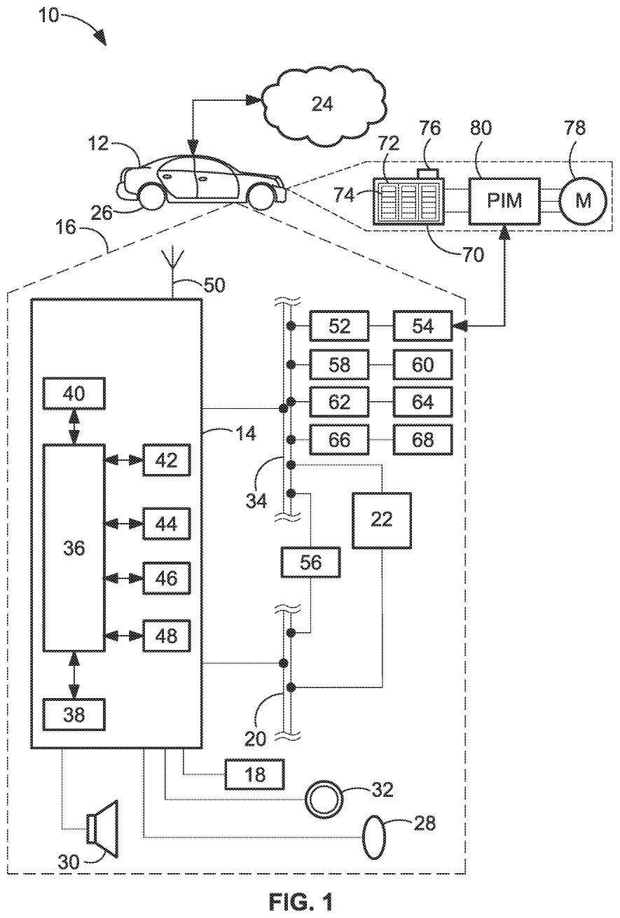

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which novel aspects of this disclosure may be practiced. In the same vein, incorporation of the present concepts into an FEV powertrain and single-pack RESS should be appreciated as a non-limiting implementation of disclosed features. As such, it will be understood that aspects and features of this disclosure may be applied to other powertrain and RESS architectures, incorporated into any logically relevant type of motor vehicle, and utilized for both automotive and non-automotive applications alike. Moreover, only select components of the motor vehicles and HV electrical systems are shown and described in additional detail below. Nevertheless, the vehicles and electrical systems discussed herein may include numerous additional and alternative features, and other available peripheral components, for carrying out the various methods and functions of this disclosure.

The representative vehicle 10 of FIG. 1 is originally equipped with a centerstack telecommunications and information (“telematics”) unit 14 that wirelessly communicates, e.g., via cell towers, base stations, mobile switching centers, satellite service, etc., with a remotely located cloud computing host service 24 (e.g., ONSTAR®). Some of the other in-vehicle hardware components 16 shown in FIG. 1 include, as non-limiting examples, an electronic video display device 18, a microphone 28, audio speakers 30, and assorted user input controls 32 (e.g., buttons, knobs, switches, touchpads, joysticks, touchscreens, etc.). These hardware components 16 function, in part, as a human/machine interface (HMI) that enables a user to communicate with the telematics unit 14 and other components resident to and remote from the vehicle 10. Microphone 28, for instance, provides occupants with means to input verbal or other auditory commands. Conversely, the speakers 30 provide audible output to a vehicle occupant and may be either a stand-alone speaker dedicated for use with the telematics unit 14 or may be part of an audio system 22. The audio system 22 is operatively connected to a network connection interface 34 and an audio bus 20 to receive analog information, rendering it as sound, via one or more speaker components.

Communicatively coupled to the telematics unit 14 is the network connection interface 34, suitable examples of which include twisted pair/fiber optic Ethernet switches, parallel/serial communications buses, local area network (LAN) interfaces, controller area network (CAN) interfaces, and the like. The network connection interface 34 enables vehicle hardware 16 to send and receive signals with one another and with various systems and subsystems both onboard and off-board the vehicle body 12. This allows the vehicle 10 to perform assorted vehicle functions, such as modulating powertrain output, activating friction and regenerative brake systems, controlling vehicle steering, regulating charge and discharge of a vehicle battery pack, and other automated functions. For instance, telematics unit 14 may receive and transmit signals to/from a Powertrain Control Module (PCM) 52, an Onboard Charging Module (OBCM) module 54, an Electronic Battery Control Module (EBCM) 56, a Steering Control Module (SCM) 58, a Brake System Control Module (BSCM) 60, and assorted other vehicle ECUs, such as a transmission control module (TCM), engine control module (ECM), Sensor System Interface Module (SSIM), etc.

With continuing reference to FIG. 1, telematics unit 14 is an onboard computing device that provides a mixture of services, both individually and through its communication with other networked devices. This telematics unit 14 is generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, a solid-state drive (SSD) memory, a hard-disk drive (HDD) memory, flash memory, semiconductor memory (e.g., various types of RAM or ROM), etc.

Long-range communication (LRC) capabilities with off-board devices may be provided via one or more or all of a cellular chipset/component, a navigation and location chipset/component (e.g., global positioning system (GPS) transceiver), or a wireless modem, all of which are collectively represented at 44. Short-range communication (SRC) may be provided via a close-range wireless communication device 46 (e.g., a BLUETOOTH® unit or near field communications (NFC) transceiver), a dedicated short-range communications (DSRC) component 48, and/or a dual antenna 50. The communications devices described above may provision data exchanges as part of a periodic broadcast in a vehicle-to-vehicle (V2V) communication system or a vehicle-to-everything (V2X) communication system. It should be understood that the vehicle 10 may be implemented without one or more of the above listed components or, optionally, may include additional components and functionality as desired for a particular end use.

CPU 36 receives sensor data from one or more sensing devices that use, for example, photo detection, radar, laser, ultrasonic, optical, infrared, or other suitable technology, including short range communications technologies (e.g., DSRC) or Ultra-Wide Band (UWB) radio technologies, e.g., for executing an automated vehicle operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of autonomous vehicle operation.

To propel the motor vehicle 10, an electrified powertrain is operable to generate and deliver tractive torque to one or more of the vehicle's drive wheels 26. The vehicle's electrified powertrain is generally represented in FIG. 1 by an electric traction motor 78 that is operatively connected to a rechargeable energy storage system (RESS), which may be in the nature of a chassis-mounted traction battery pack 70. The traction battery pack 70 is generally composed of one or more battery modules 72 each containing a group of electrochemical battery cells 74, such as lithium ion, lithium polymer, or nickel metal hydride battery cells. Traction motor/generator (M) unit 78 draws electrical power from and, optionally, delivers electrical power to the battery pack 70. A power inverter module (PIM) 80 electrically connects the battery pack 70 to the motor/generator unit(s) 78 and modulates the transfer of electrical current therebetween. The battery pack 70 may be configured such that module management, cell sensing, and module-to-module or module-to-host communications functionality is integrated directly into each module 72 and performed wirelessly via a wireless-enabled cell monitoring unit (CMU) 76.

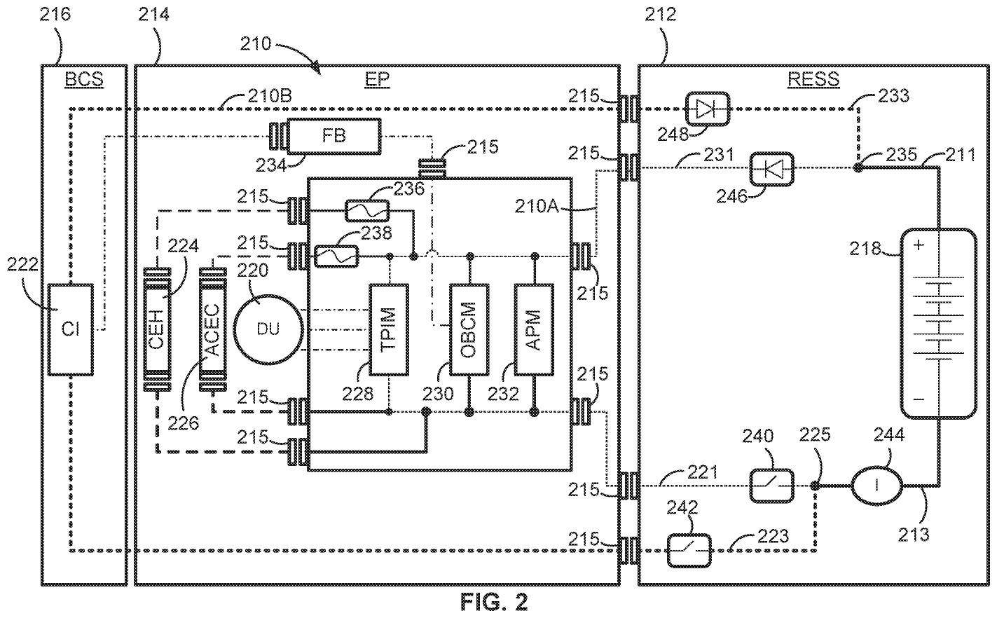

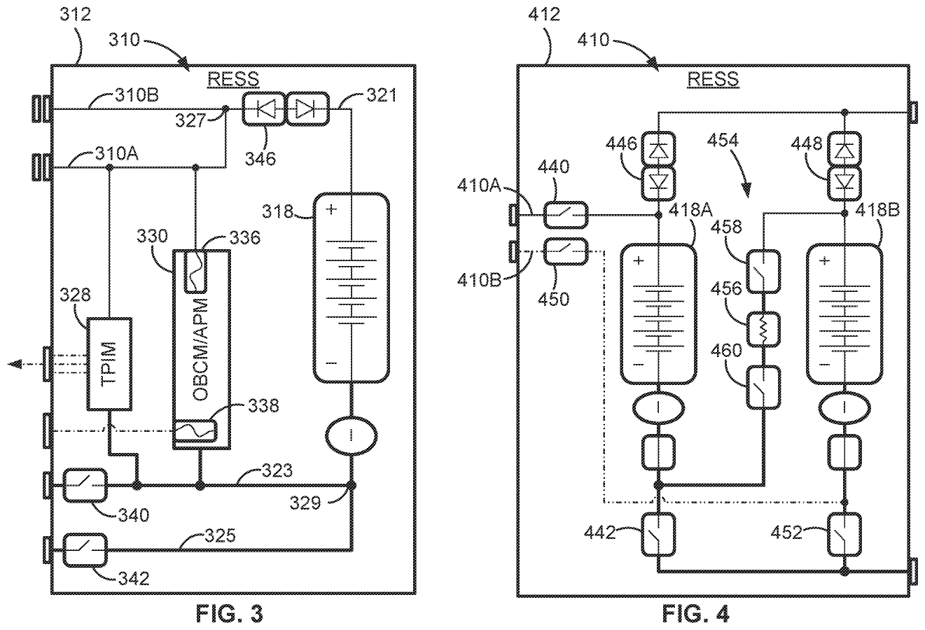

Turning next to FIGS. 2-4, there are shown three non-limiting examples of high-voltage electrical systems, generally designated at 210, 310 and 410, respectively, that are adapted for selectively electrically connecting and disconnecting a high-voltage power source, such as the RESS battery pack 70 of FIG. 1, to a high-voltage load, such as FEV powertrain motor 78 of automobile 10 of FIG. 1. Although differing in appearance, it is envisioned that any of the features and options described below with reference to the electrical system 210, RESS 212, powertrain 214, and charging system 216 of FIG. 2 may be incorporated, singly or in any combination, into the HV electrical systems 310, 410 of FIGS. 3 and 4, and vice versa. By way of example, each HV electrical system 210, 310, 410 connects a single HV battery pack 218 (FIG. 2) or multiple HV battery packs 418A and 418B (FIG. 4) of a rechargeable energy storage system (RESS) 212 to both an electric motor 220 of an electrified powertrain (EP) 214 and a charge inlet (CI) 222 of a battery charging system (BCS) 216. It is envisioned that the individual systems and subsystems illustrated in FIG. 2 may include additional and alternative hardware and other available peripheral components without departing from the intended scope of this disclosure.

Acting as a primary load of current draw, the motor 220 may be embodied as an integrated electric drive unit (DU) containing a polyphase motor generator unit (MGU), a multi-ratio gearbox, and a power electronics package. Acting as a primary interface for an offboard charge point, the charge inlet 222 may be embodied as a charging cable connector port or a wireless charging EMF pad that is compatible for wired or wireless connection with a Level 2 AC EVCS or a Level 3 DCFC vehicle charging station. RESS 212 of FIG. 2 is portrayed as a single-pack variant with a high-capacity, deep-cycle traction battery pack 218 that is arranged between and connected across positive and negative bus rails 211 and 213, respectively, of a battery-side, high-voltage DC bus. The battery pack 218 has corresponding cathode/positive (+) and anode/negative (−) terminals that respectively couple the pack 218 to the positive and negative bus rails 211, 213. Reference to either terminal as “anode” or “cathode” or, for that matter, as “positive” or “negative” does not limit the battery terminals to a particular polarity as the system polarity may change depending on whether the battery pack 218 is being operated in a charge mode or a discharge mode. To that end, reference to one feature as “upstream” or “downstream” from another feature will depend on the charge/discharge state of the battery and, thus, the flow direction of current across the electrical system.

The exemplary system architectures described below with reference to FIGS. 2-4 enable improved high-power connect and galvanic disconnect of the HV power source to/from the various HV loads and the off-board HV charging source. The HV electrical system 210 of FIG. 2, for example, may be bifurcated into two distinct circuit loops: a first (main) circuit loop 210A that electrically connects the RESS 212 to the electrified powertrain 214; and a second (DCFC) circuit loop 210B that is parallel to the first circuit loop 210A and electrically connects the RESS 212 to the battery charging system 216. Representative electrical loads on the main loop 210A of the electrical system 210 may include, but are not limited to, a cabin electric heater (CEH) 224, an air conditioning electric compressor (ACEC) 226, a traction power inverter module (TPIM) 228 (also referred to in the art as “single power inverter module” or SPIM), an onboard charging module (OBCM) 230, and an accessory power module (APM) 232. For dual-pack configurations, such as that shown in FIG. 4, the RESS 212 and charging system 216 may employ a dedicated power inverter module and a dedicated charging module for each pack. It is also within the scope of this disclosure to add, eliminate, or combine one or more of the power electronics (PE) modules and electrical loads shown in FIG. 2. Moreover, the hereinbelow described BDU switches may be packaged outside of the traction battery pack 218 (as shown) or may be packaged on or in the pack.

When battery charging is desired, the OBCM 230 may monitor and selectively govern the charging rate, current, voltage, start/stop times, etc., of a wired or wireless charging event. The OBCM 230 may also function as an AC-to-DC converter to convert an alternating-current (AC) charging voltage from the electronic drive unit (DU) 220 or an off-board AC power supply into a DC voltage suitable for use by the battery pack 218. An electrical fuse box (FB) 234, which contains one or more overcurrent protection devices, is electrically interposed between and passively disconnects the charge inlet 222 and the OBCM 230. A heater (HTR) fuse 236 may be electrically interposed between the CEH 224 and the RESS 212, whereas an air conditioner (ACEC) fuse 238 may be electrically interposed between the ACEC 226 and the RESS 212. There are also sixteen (16) different wiring/cabling connectors 215 in FIG. 2 at various interface locations between the RESS 212, powertrain 214, and charging system 216 and at various interface locations between the interoperable electrical hardware components on the circuit loops 210A, 210B.

To facilitate HV connect and complete galvanic disconnect between the RESS 212 and powertrain 214, a first (main) electrochemical contactor switch 240 is located on the first circuit loop 210A of the HV electrical system 210. This contactor switch 240 is electrically connected in series (i.e., “serially connected”) with the motor-housing drive unit 220, e.g., via TPIM 228, and a first terminal of the battery pack 218, e.g., anode terminal (−). During a battery discharge event, the first contactor switch 240 is commanded to close; in so doing, the contactor 240 is located upstream from the battery pack 218 and downstream from the DU 220. To facilitate HV connect and complete galvanic disconnect between the RESS 212 and battery charging system 216, a second (DCFC) electrochemical contactor switch 242 is located on the electrical system's second circuit loop 210B. This contactor switch 242 is electrically connected in series with the charge inlet 222 and the same battery terminal as the first contactor switch 240, e.g., the anode terminal (−). During a battery recharge event, the second contactor switch 242 is commanded to close; in so doing, the contactor 242 is located downstream from the battery pack 218 and upstream from the charge inlet 222. An optional current sensor and shunt resistor device (I) 244 may be electrically interposed between the battery pack 218 and the two contactor switches 240, 242 to monitor the flow of DC current into and out of the pack 218.

In the illustrated example, the first contactor switch 240 is located on a distinct (third) circuit branch 221 of the first circuit loop 210A, and the second contactor switch 242 is located on a distinct (fourth) circuit branch 223 of the second circuit loop 210B. The two contactor switch-bearing circuit branches 221, 223 electrically connect to each other at an anode-side (second) T-junction node 225, which connects the two contactors 240, 242 and their respective branches 221, 223 to the battery pack 218. Using the electrically controlled switch architectures of FIGS. 2-4, all three HV electrical systems 210, 310, 410 eliminate the need for a pre-charge (PC) circuit that is electrically connected in parallel with either contactor switch 240, 242. As explained above, a PC circuit may be typified by a PC contactor that is serially connected to a PC resistor, both of which are electrically connected in parallel (i.e., “parallel connected”) to a contactor. Examples of HV electrical systems employing pre-charge circuits can be found in U.S. Patent and U.S. Pat. Nos. 10,369,900 B1, 11,511,632 B2, and 2021/0078442 A1, all of which are incorporated herein by reference in their respective entireties and for all purposes.

To facilitate pulsed HV connect and arc-free disconnect between the RESS 212 and powertrain 214, a first (main) SSR switch 246 is located on the first circuit loop 210A of the HV electrical system 210 and electrically interposed between the pack 218 and the powertrain's various electrical loads (e.g., DU 220, CEH 224, ACEC 226, TPIM 228, OBCM 230, APM 232, etc.). This SSR switch 246 is serially connected with the drive unit 220 motor, e.g., via TPIM 228, and a second terminal of the battery pack 218, e.g., cathode terminal (+). For optimized RESS-to-powertrain connect/disconnect functionality, the first SSR switch 246 is operatively paired with and serially connected to the first contactor switch 240 across the battery pack 218 (i.e., battery pack 218 is electrically interposed between the SSR 246 and its mated contactor 240). During a battery discharge event, the first SSR switch 246 is commanded to close; in so doing, the SSR 246 is located downstream from the battery pack 218 and upstream from the DU 220. Upon closing, the first SSR switch 246 of FIG. 2 functions to serially connect the battery pack's cathode terminal (+) to the DU 220 and thereby transmits current from the pack 218 to the DU 220 motor in a first direction (e.g., counterclockwise in FIG. 2).

To facilitate pulsed HV connect and arc-free disconnect between the RESS 212 and battery charging system 216, a second (DCFC) SSR switch 248 is located on the second circuit loop 210B and electrically interposed between the pack 218 and an off-board power source (e.g., a Level 3 DC charging cable plugged into CI 222). This SSR switch 248 is serially connected with the charge inlet 222 and the same battery terminal as the first SSR switch 246, e.g., cathode terminal (+). For optimized RESS-to-CI connect/disconnect functionality, the second SSR switch 248 is operatively paired with and serially connected to the second contactor switch 242 across the battery pack 218. During a battery recharge event, the second SSR switch 248 is commanded to close; in so doing, the SSR 248 is located upstream from the battery pack 218 and downstream from the CI 222. Upon closing, the second SSR switch 248 functions to serially connect the battery's cathode terminal (+) to the BCS CI 222 and thereby transmits current from the pack 218 to the battery charging system 216 in a second direction (e.g., clockwise in FIG. 2).

In the example architecture illustrated in FIG. 2, the first SSR switch 246 is located on a distinct (first) circuit branch 231 of the first circuit loop 210A, and the second SSR switch 248 is located on a distinct (second) circuit branch 233 of the second circuit loop 210B. The two SSR switch-bearing circuit branches 231, 233 electrically connect to each other at a cathode-side (first) T-junction node 235, which connects the two SSRs 246, 248 and their respective branches 231, 233 to the battery pack 218. For a single-pack, dual-relay architecture, such as the example shown in FIG. 2, it may be desirable that each SSR switch 246, 248 be a high-speed, unidirectional semiconductor switch device, e.g., containing IGBTs, MOSFETs, ICs, etc., that is electronically controlled by a suitable control device. It is envisioned that both contactor switches 240, 242 may be serially connected directly to the anode battery terminal (−) and both SSR switches 246, 248 may be serially connected directly to the cathode battery terminal (+), as shown. Alternatively, both contactors 240, 242 may be serially connected to the cathode terminal (+) and both SSRs 246, 248 may be serially connected to the anode terminal (−).

Selective electrical connection and disconnection of the RESS 212 to/from the EP 214 and BCS 216 may be governed by a resident or remote electronic control unit or module or network for controller/modules (collectively “system control module”), such as CPU 36, telematics processors 40, PCM 52, EBCM 56, and/or OBCM 230. The system control module is programmed to receive, process, and respond accordingly to various battery discharge and charge requests. Upon receipt of a battery discharge request signal, for example, the system control module may responsively transmit command signals that first close the first contactor switch 240, then substantially simultaneously close the first SSR switch 246, while concurrently opening both the second contactor switch 242 and the second SSR switch 248. Conversely, upon receipt of a battery charge request signal, the system control module may responsively transmit command signals that first close the second contactor switch 242, then substantially simultaneously close the second SSR switch 248, while concurrently opening both the first contactor switch 240 and the first SSR switch 246.

FIG. 3 illustrates another example of a single-pack RESS 312 configuration with a lone battery pack 318 that is selectively connected to and disconnected from an electrified powertrain (e.g., EP 214 of FIG. 2) and a battery charging system (e.g., BCS 216 of FIG. 2) via an HV electrical system 310. Similar to the HV electrical system 210 of FIG. 2, the HV electrical system 310 of FIG. 3 may be bifurcated into two mutually parallel circuit loops: a first (main) circuit loop 310A that electrically connects the RESS 312 to the powertrain loads; and a second (DCFC) circuit loop 310B that electrically connects the RESS 312 to a charge inlet/port. Also comparable to the HV electrical system 210, the electrical system 310 employs a first (main) electrochemical contactor switch 340, which is located on the first circuit loop 310A and serially connected with a motor and a first terminal of battery pack 318, and a second (DCFC) electrochemical contactor switch 342, which is located on the second circuit loop 310B and serially connected with a charge inlet and the first battery terminal. As noted above, the HV electrical system 310 may include any of the options and features described herein with respect to the electrical systems 210, 410, and vice versa.

In contrast to the other system architectures, the RESS 312 of FIG. 3 is shown containing a TPIM 328, a combination OBCM/APM PE module 330, and an OBCM/APM fuse 336. As another point of demarcation, the HV electrical system 310 utilizes a single bidirectional (main/DCFC) SSR switch 346 that is operatively paired with and serially connected to both of the contactors switches 340, 342 across the battery assembly 318. This bidirectional SSR switch 346 is located on both of the circuit loops 310A, 310B, is electrically connected to a second terminal of the battery pack 318 opposite that of the contactors 340, 342, and is serially connected to both the motor and charge inlet. In the illustrated example, the bidirectional SSR switch 346 is located on a first circuit branch 321, the first contactor switch 340 is located on a second circuit branch 323 distinct from the first branch 321, and the second contactor switch 342 is located on a third circuit branch 325 distinct from the other two branches 321, 323. With this arrangement, the first circuit branch 321 connects via one T-junction node 327 to the first and second circuit loops 310A, 310B, whereas the second and third circuit branches 323, 325 connect to each other and to the battery pack 318 via another T-junction node 329.

FIG. 4 illustrates a dual-pack RESS 412 configuration with two HV power sources—e.g., first and second battery packs 418A and 418B—that selectively connect to and disconnect from an HV electrical load (e.g., EP 214 of FIG. 2) and a HV charging source (e.g., BCS 216 of FIG. 2) via an HV electrical system 410. In this example, a first (main/DCFC) bidirectional SSR switch 446 is located on both first and second circuit loops 410A and 410B and serially connected with a second (cathode/positive) battery terminal of the first battery pack 418A. A second (main/DCFC) bidirectional SSR switch 448 is located on both of the circuit loops 410A, 410B serially connected with a second (cathode/positive) battery terminal of the second battery pack 418B. A first electromechanical contactor switch 440 is serially connected to the first bidirectional SSR switch 446 and the second (cathode/positive) battery terminal, whereas a second electromechanical contactor switch 442 is serially connected to the first (anode/negative) battery terminal and the first bidirectional SSR switch 446 across the battery pack 418A. Third and fourth electromechanical contactor switches 450 and 452, respectively, are serially connected to the first (anode/negative) terminal of the second battery pack 418B and the second bidirectional SSR switch 448 across the pack 418B. A battery circuit branch (BCB) 454 serially connects the first (anode/negative) terminal of the first battery pack 418A to the second (cathode/positive) terminal of the second battery pack 418B. This battery circuit branch 454 includes a BCB electrical fuse 456 that is serially connected to and electrically interposed between two BCB contactor switches 458 and 460.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A high-voltage (HV) electrical system for connecting a battery assembly of a rechargeable energy storage system (RESS) to an electric motor of an electrified powertrain and a charge inlet of a battery charging system, the HV electrical system comprising:
a first circuit loop configured to connect the RESS to the electrified powertrain;
a second circuit loop parallel to the first circuit loop and configured to connect the RESS to the charge inlet;
a first contactor switch on the first circuit loop and configured to electrically connect in series with the electric motor and a first battery terminal of the battery assembly;
a second contactor switch on the second circuit loop and configured to electrically connect in series with the charge inlet and the first battery terminal; and
a solid-state relay (SSR) switch serially connected with the first contactor switch and/or the second contactor switch across the battery assembly and configured to electrically connect in series with a second battery terminal and the electric motor and/or the charge inlet.

2. The HV electrical system of claim 1, wherein the SSR switch includes:
a first SSR switch on the first circuit loop and serially connected to the first contactor switch across the battery assembly; and
a second SSR switch on the second circuit loop and serially connected to the second contactor switch across the battery assembly.

3. The HV electrical system of claim 2, wherein the first SSR switch is operable to selectively serially connect the second battery terminal to the electric motor and thereby transmit current from the second battery terminal in a first direction, and the second SSR switch is operable to selectively serially connect the charge inlet to the second battery terminal and thereby transmit current to the second battery terminal in a second direction opposite the first direction.

4. The HV electrical system of claim 2, wherein the first SSR switch is located on a first circuit branch, the second SSR switch is located on a second circuit branch, and the first and second circuit branches connect at a first T-junction.

5. The HV electrical system of claim 4, wherein the first contactor switch is located on a third circuit branch, the second contactor switch is located on a fourth circuit branch, and the third and fourth circuit branches connect at a second T-junction.

6. The HV electrical system of claim 2, further comprising a system control module programmed to:
receive a battery discharge request signal; and
responsive to receiving the battery discharge request signal, transmit command signals to close the first contactor switch and the first SSR switch and open the second contactor switch and the second SSR switch.

7. The HV electrical system of claim 6, wherein the system control module is further programmed to:
receive a battery charge request signal; and
responsive to receiving the battery charge request signal, transmit command signals to close the second contactor switch and the second SSR switch and open the first contactor switch and the first SSR switch.

8. The HV electrical system of claim 2, characterized by a lack of a pre-charge circuit electrically connected in parallel with either of the first and second contactor switches, the pre-charge circuit including a pre-charge contactor serially connected to a pre-charge resistor.

9. The HV electrical system of claim 2, wherein the first and second SSR switches each includes a respective unidirectional electronic semiconductor switch device.

10. The HV electrical system of claim 1, wherein the SSR switch includes a bidirectional SSR switch on both the first and second circuit loops and serially connected to both the first and second contactor switches across the battery assembly.

11. The HV electrical system of claim 10, wherein the bidirectional SSR switch is located on a first circuit branch, the first contactor switch is located on a second circuit branch, the second contactor switch is located on a third circuit branch, and the second and third circuit branches connect at a first T-junction.

12. The HV electrical system of claim 1, wherein the battery assembly includes first and second battery assemblies, and wherein the SSR switch includes:
a first bidirectional SSR switch on both the first and second circuit loops and configured to serially connect with the second battery terminal of the first battery assembly; and
a second bidirectional SSR switch on both the first and second circuit loops and configured to serially connect with the second battery terminal of the second battery assembly.

13. The HV electrical system of claim 12, further comprising a battery circuit branch configured to serially connect the first battery terminal of the first battery assembly to the second battery terminal of the second battery assembly, the battery circuit branch including an electrical fuse serially connected to and interposed between third and fourth contactor switches.

14. A motor vehicle, comprising:
a vehicle body;
a plurality of road wheels attached to the vehicle body;
an electrified powertrain with an electric traction motor attached to the vehicle body and operable to drive one or more of the road wheels to thereby propel the motor vehicle;
a rechargeable energy storage system (RESS) with a battery assembly attached to the vehicle body and including first and second battery terminals;
a vehicle battery charging system with a charge inlet attached to the vehicle body and configured to electrically connect to an off-board power source; and
a high-voltage (HV) electrical system attached to the vehicle body, the HV electrical system including:
a first circuit loop electrically connecting the RESS to the electrified powertrain;
a second circuit loop parallel to the first circuit loop and electrically connecting the RESS to the charge inlet;
a first contactor switch on the first circuit loop and electrically connected in series with the electric traction motor and the first battery terminal;
a second contactor switch on the second circuit loop and electrically connected in series with the charge inlet and the first battery terminal; and
a solid-state relay switch electrically connected in series with the second battery terminal, the electric traction motor and/or the charge inlet, and the first contactor switch and/or the second contactor switch across the battery assembly.

15. A method of assembling a high-voltage (HV) electrical system for connecting a battery assembly of a rechargeable energy storage system (RESS) to an electric motor of an electrified powertrain and a charge inlet of a battery charging system, the method comprising:
connecting the RESS to the electrified powertrain via a first circuit loop;
connecting the RESS to the charge inlet via a second circuit loop parallel to the first circuit loop;
connecting a first contactor switch to the first circuit loop in electrical series with the electric motor and a first battery terminal of the battery assembly;
connecting a second contactor switch to the second circuit loop in electrical series with the charge inlet and the first battery terminal;
connecting a solid-state relay (SSR) switch in electrical series with the first contactor switch and/or the second contactor switch across the battery assembly; and
connecting the SSR switch in electrical series with a second battery terminal of the battery assembly and the electric motor and/or the charge inlet.

16. The method of claim 15, wherein the SSR switch includes first and second SSR switches, the method further comprising:
connecting the first SSR switch to the first circuit loop in electrical series with the first contactor switch across the battery assembly; and
connecting the second SSR switch to the second circuit loop in electrical series with the second contactor switch across the battery assembly.

17. The method of claim 16, wherein the first SSR switch is operable to serially connect the second battery terminal to the electric motor and thereby transmit current from the second battery terminal in a first direction, and the second SSR switch is operable to serially connect the charge inlet to the second battery terminal and thereby transmit current to the second battery terminal in a second direction opposite the first direction.

18. The method of claim 16, further comprising:
locating the first SSR switch on a first circuit branch;
locating the second SSR switch on a second circuit branch; and
connecting the first and second circuit branches at a first T-junction.

19. The method of claim 18, further comprising:
locating the first contactor switch on a third circuit branch;
locating the second SSR switch on a fourth circuit branch; and
connecting the third and fourth circuit branches at a second T-junction.

20. The method of claim 16, wherein the first and second SSR switches each includes a respective unidirectional electronic semiconductor switch device.
